(19) United States
(12) Patent Application Publication
(10) Pub. No.: US 2011/0304130 A1
(43) Pub. Date: Dec. 15, 2011

(54) Identifying Film for Optical Code

(76) Inventor: Hung-Terng Leu, Taipei City (TW)

(21) Appl. No.: 12/813,669

(22) Filed: Jun. 11, 2010

(51) Int. Cl. B42D 1/00

(52) U.S. Cl. 281/15.1

(57) ABSTRACT

An identifying film for an optical code contains a book including a flexible substrate fitted thereon, and the flexible substrate including: at least one displaying area having a plurality of dots arranged therein, and each dot including various information; at least one selecting area having a number of different dot positions arranged therein; thereby, the reader allows to select the desired item on the basis of requirement, and selected data are judged via the dots in the displaying area by using other reading devices so as to generate different display effects, hence the identifying film is portable easily by reader to read more contents and information in different display types.

### BACKGROUND OF THE INVENTION

1. Field of the Invention

The present invention relates to a tool with reading and listening functions, and more particularly to an identifying film for an optical code that can display contents in the book in various types to be read.

2. Description of the Prior Art

Internet is an important and indispensable technology for people, but it can not replace books which can enhance spirit, temperament, and knowledge. The books sold in market are read by readers by ways of static letters or figures shown in the books, but such letters and figures can not be transformed into vivid images or sounds to be read. Moreover, the books are in a larger size and will get wet or broken after being stored in a long period of time, therefore an insertable electronic dictionary is developed to improve defects of the books. The electronic dictionary includes a memory card to store data of the books inserted therein so that the reader can read the data via the images and the sounds made from the electronic dictionary, however such an electronic dictionary is expensive and operated complicatedly that can not become popular.

Another conventional reading tool is apply a compact disk (CD) to store data of the books, hence when the reader intends to read the data, the CD is put into a CD player, personal computer, or notebook, and a software is used to read the data through the images and the sounds, but such a reading method (such as the computer installed the software therein) is expensive, and the software is only applicable for a user who is familiar with the computer or the software, accordingly it is not popular and economical for people.

The present invention has arisen to mitigate and/or obviate the afore-described disadvantages.

### SUMMARY OF THE INVENTION

The primary object of the present invention is to provide an identifying film for an optical code that allows the reader to select the desired item on the basis of requirement, and selected data are judged via the dots in the displaying area by using other reading devices so as to generate different display effects, hence the identifying film is portable easily by reader to read more contents and information in different display types.

Secondary object of the present invention is to provide an identifying film for an optical code that is capable of transforming contents in a conventional book into vivid images and sounds to be outputted so as the contents in the conventional book are read in an image and sound types.

Further object of the present invention is to provide an identifying film for an optical code that is capable of lowering cost and being operated easily so as to be used as a popular auxiliary teaching tool.

Another object of the present invention is to provide an identifying film for an optical code that is decreased size so as to be stored in a small space.

To obtain the above objectives, an identifying film for an optical code provided by the present invention contains

a book including a flexible substrate fitted thereon, and the flexible substrate including:

at least one displaying area having a plurality of dots arranged therein, and each dot including various information;

at least one selecting area having a number of different dot positions arranged therein.

### BRIEF DESCRIPTION OF THE DRAWINGS

FIG. 1 is a perspective view showing the assembly of an identifying film for an optical code according to a preferred embodiment of the present invention;

FIG. 2 is a perspective view showing the exploded components of the identifying film for the optical code according to the preferred embodiment of the present invention;

FIG. 3 is a perspective view showing the operation of the identifying film for the optical code according to the preferred embodiment of the present invention;

FIG. 4 is another perspective view showing the operation of the identifying film for the optical code according to the preferred embodiment of the present invention;

FIG. 5 is another perspective view showing the operation of the identifying film for the optical code according to the preferred embodiment of the present invention;

FIG. 6 is another perspective view showing the operation of the identifying film for the optical code according to the preferred embodiment of the present invention;

FIG. 7 is another perspective view showing the operation of the identifying film for the optical code according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

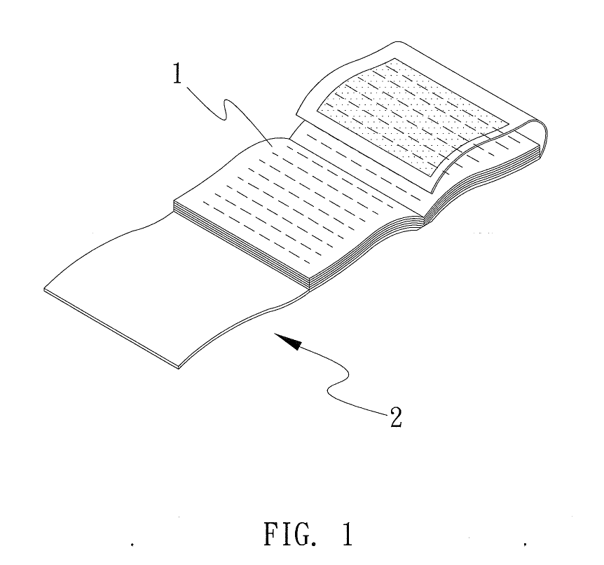

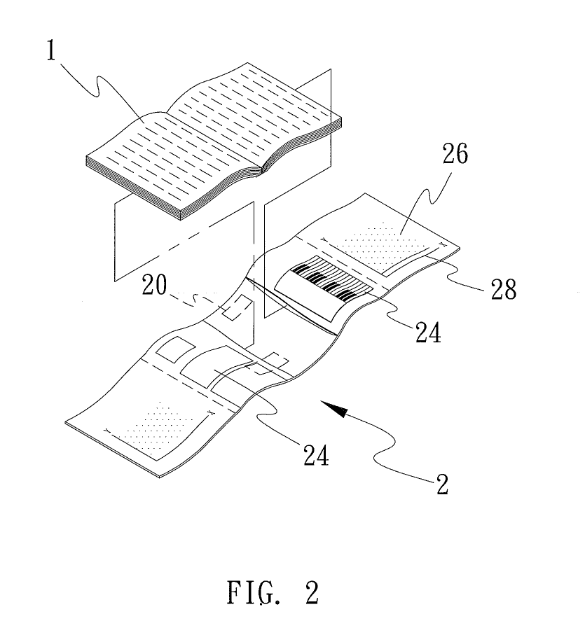

With reference to FIGS. 1 and 2, an identifying film for an optical code is comprised of a book 1 and a flexible substrate 2 (such as a transparent or opaque substrate), wherein the flexible substrate 2 on the book 1 is set based on requirement, and its usage type is changed with the change of the book 1, the flexible substrate 2 includes a displaying area 22 and a selecting area 24 (such as an education and entertainment item, a teaching item, numerals, letters or patterns), hence dots of the displaying area 22 and the selecting area 24 are used by a reader to select a desired item based on requirement by ways of a reading device 3, and data are displayed before the reader through the dots 26 of the displaying area 22. In addition, the displaying area 22 includes a coordinate 28 to define X and Y axes extending and arranged in the displaying area 22 to provide an exact position to the dots 26.

When the book 1 is used to match with the flexible substrate 2, the flexible substrate 2 is covered on a cover sheet of the book 1, and two pages of the flexible substrate 2 are shown in the selecting area 24 after covering the flexible substrate 2 on the book 1, the selecting area 24 includes the education and entertainment item, the teaching item, numerals, letters, or patterns displayed therein, and includes a plurality of displaying areas 22 of the dots, and each displaying area 22 is acquired from a data base and includes various information.

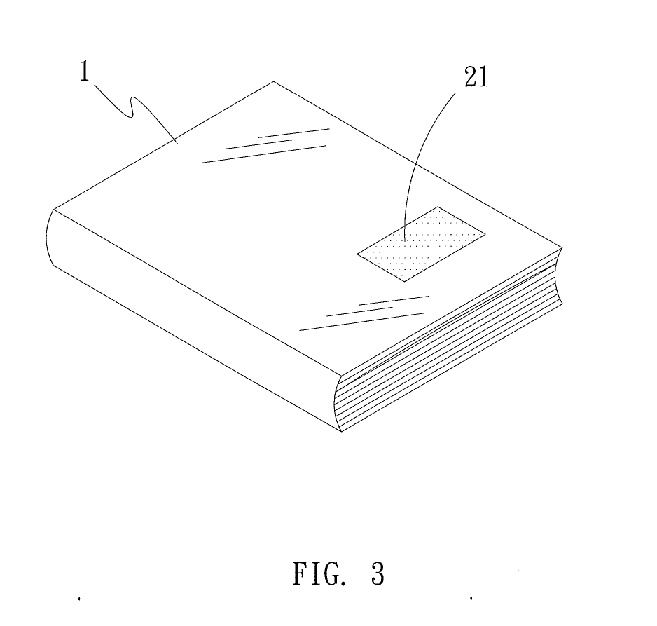

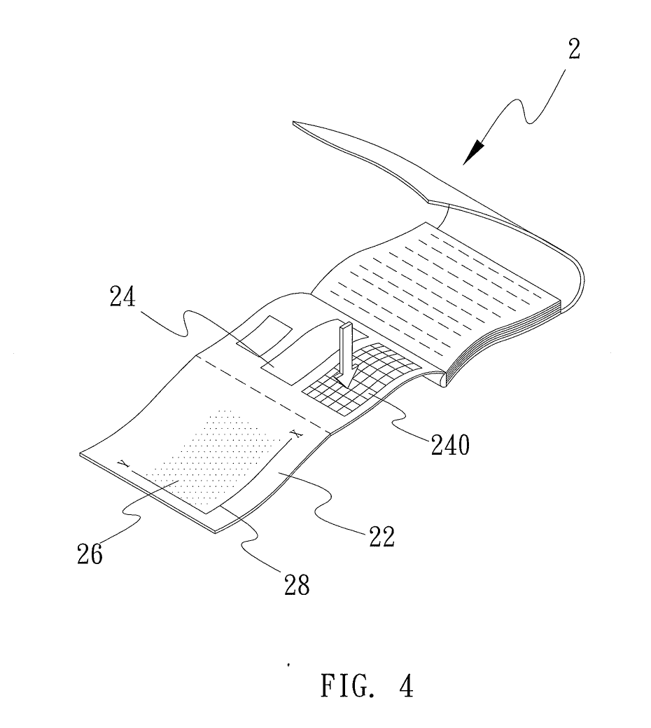

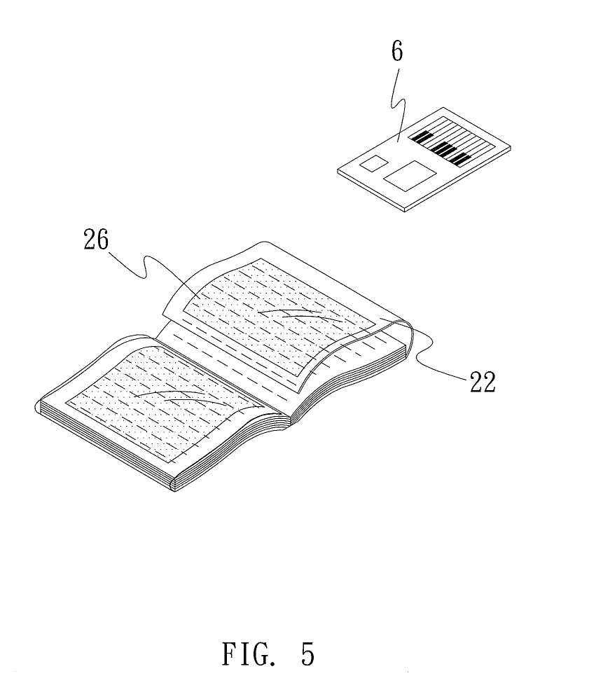

In operation, as illustrated in FIGS. 2-5, the flexible substrate 2 is fitted on the book 1 (the flexible substrate 2 allows to match with an appearance of the book), and the book 1 includes a contacting area 21 formed on a cover thereof to provide selective reading types, the dots in the contacting area 21 are read by using other reading devices (not shown), and the flexible substrate 2 includes the displaying area 22 and the selecting area 24, the selecting area 24 further includes a page number display zone 240 to provide its page number to be selected by the reader based on requirement, thereby after the reader identifies desired reading contents from the contacting area 21, he/she further selects the desired read page number from the page number display zone 240, and then the displaying area 22 is used to correspond to the desired page number.

The reader allows to apply a selected item from the selecting area 24 according to desired information so as to judge the dots 26 of the coordinate 28 via other reading devices (not shown).

A choosing card 3 is provided to correspond to the selecting area 24 so that the user chooses the desired item by using the choosing card 3 without turning the book.

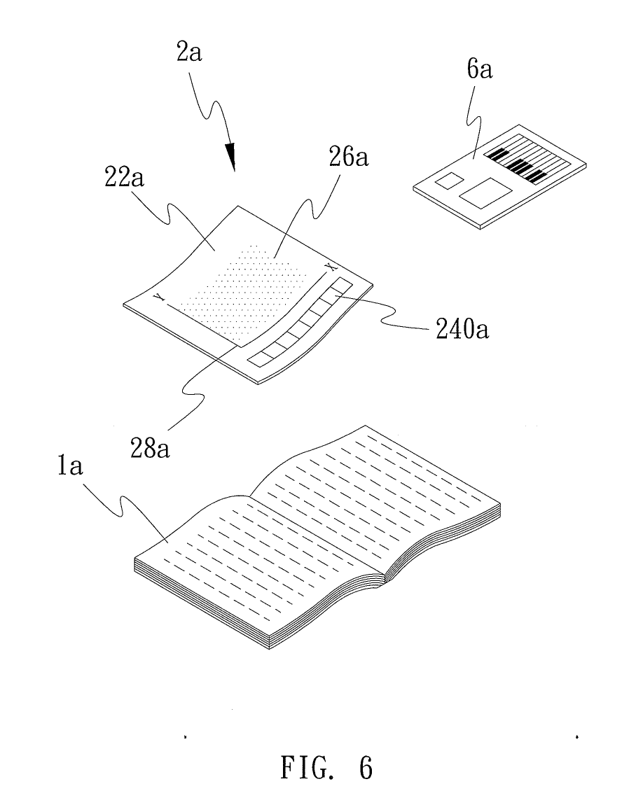

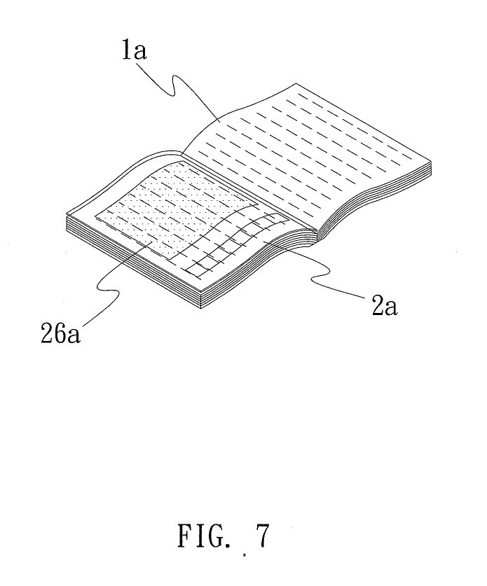

Referring to FIGS. 6 and 7, when a flexible substrate 2a is a single sheet, the reader allows to cooperate with a choosing card 3a to choose a desired item. For example, the reader puts the flexible substrate 2a into a desired reading page number of a book 1a, and then selects a corresponding page number through a page number display zone 240a on the flexible substrate 2a. In the meantime, dots 26a of a displaying area 22a are displayed on a coordinate 28a with X and Y axes and seen by the reader, and the dots 26a after a selecting process are shown on the displaying area 22a so that other reading devices (not shown) are able to judge the dots 26a on the coordinate 28a and the choosing card 3a.

Thereby, the reader allows to select the desired item on the basis of requirement, and selected data are judged via the dots 26 in the displaying area 22 by using other reading devices so as to generate different display effects, hence the identifying film is portable easily by reader to read more contents and information in different display types.

While we have shown and described various embodiments in accordance with the present invention, it is clear to those skilled in the art that further embodiments may be made without departing from the scope of the present invention.

What is claimed:

1. An identifying film for an optical code comprising
a book including a flexible substrate fitted thereon, and the flexible substrate including:
at least one displaying area having a plurality of dots arranged therein, and each dot including various information;
at least one selecting area having a number of different dot positions arranged therein.

2. The identifying film for the optical code as claimed in claim 1, wherein the displaying area further a coordinate to provide an exact position to the dots via the flexible substrate

3. The identifying film for the optical code as claimed in claim 2, wherein the coordinate is used to define X and Y axes so that the dots extend and are arranged in the displaying area.

4. The identifying film for the optical code as claimed in claim 1 further comprising a choosing card to correspond to the selecting area.

5. The identifying film for the optical code as claimed in claim 1, wherein the selecting area further includes a page number display zone.

6. The identifying film for the optical code as claimed in claim 1, wherein the selecting area further includes an education and entertainment item, a teaching item, numerals, letters or patterns.

7. The identifying film for the optical code as claimed in claim 1, wherein the flexible substrate is selected from a transparent and an opaque substrates.

8. The identifying film for the optical code as claimed in claim 1, wherein the flexible substrate further including a contacting area formed on a cover of the book to provide selective reading types.

9. The identifying film for the optical code as claimed in claim 8, wherein the contacting area includes data to correspond to displayed contents in the flexible substrate and a reading device.
